(19) United States
(12) Patent Application Publication
(10) Pub. No.: US 2014/0175179 A1
(43) Pub. Date: Jun. 26, 2014

(54) CONTEXT AWARE PASSCODES

(71) Applicant: Robert Carter, Luxembourg (LU)

(72) Inventor: Robert Carter, Luxembourg (LU)

(21) Appl. No.: 14/136,536

(22) Filed: Dec. 20, 2013

Related U.S. Application Data
(60) Provisional application No. 61/740,644, filed on Dec. 21, 2012.

(51) Int. Cl. G06K 19/06

(52) U.S. Cl. CPC G06K 19/06037
USPC 235/494

(57) ABSTRACT

A three-dimensional quick response code includes a first quick response code appended to a second quick response code to form a stack. The first quick response code has a different generation than a generation of the second quick response code. The stack creates a family tree of codes that belong to a single group of a transactional business process.

### BACKGROUND

1. Field of the Invention

The present application relates generally to electronic passcode protection.

2. Description of Related Art

Passcodes are usually a string of characters that are used to control and restrict access into electronic or physical areas or domains that contain non-public data or data that belong to process sensitive systems to properly authenticated users only. While several aspects of the underlying passcode security are increasingly at risk, it has become a major task to improving current password methods and systems including their provisioning in order to provide the necessary minimum level of passcode security to ensuring the proper protecting of computer networks and critical infrastructures. This invention discloses how passcodes and their provisioning are significantly improved by associating and equipping them with unique time and location aware attributes hence making passcodes context aware.

The use of shared secrets to identify persons that belong to a specific group of people that were granted certain privileges for example to access a certain closed area are known since long. Nowadays such shared secrets or passcodes are more and more deployed to protect user' data and privacy. Especially since the beginnings of the internet era sensitive data and confidential information were kept off-site and are stored on remote servers. This is becoming increasingly widespread and important hence requiring the protection of private data and information through passcode-based access systems.

Passcode generation and provisioning are well known in the art especially as part of authentication systems whereby the passcode is considered as one of the three core authentication factors. Single factor and two factor authentication methods usually deploy passcode provisioning while such methods often rely on the generation of one-time-passcodes or OTP.

Passcode generation in a mobile environment use more and more so-called time dependent passcode, codes which are only valid for a limited period of time. Such time dependency is usually in combination with the generation of an OTP which results in a situation that after the time restriction regarding the validity of the code has lapsed a new OTP is generated again with time limited validity.

Often such methods are used in combination with techniques that provide for lock-out periods when OTP were unsuccessfully validated so that every time a further unsuccessful attempt is made the user is required to wait an even longer time before the next attempt can be made to provide a passcode. After a predefined number of unsuccessful attempts the user is locked out for a specific time or even indefinitely.

Access systems adopted by cellular phones use such methods whereby after three unsuccessful PIN attempts the user may gain access again when a separate passcode also referred as the PUK (PIN Unlock Key) is used. Similar methods or variations thereof are used by internet based mail services whereby the PIN is the password and the PUK is replaced by a mutually agreed security question and subsequent answer such as “what is the name of your dog?”

Alternatively OTPs are provided to the user via a secondary communication channel. Using a second communication channel is often referred to as Out-of-Band (OoB) communication. An example is the use of SMS (Short Message System) text messaging in banking applications which provide a code which the user needs to provide to confirm a transaction. This method is in some European countries known as mTAN (mobile TAN).

The above systems are already in place for many years and the security which was warranted by the complication of the passcode in the past has eroded over time due to new technologies and improved and cheaper hardware which makes passcode hacking easy and fast. These techniques are generally available and many sources available on the internet provide to the potential passcode hacker many variations on the theme.

The above examples show that there is a clear need to improve the security of generating in a safe way of passcodes. At the other hand the provisioning thereof as part of networked authentication systems or even as a stand-alone application at the other.

For the purpose of the disclosures herein reference is made to publication WO2010/043722 dated 22 Apr. 2010 describing methods using localisation for multifactor authentication and WO2011/048106 dated 28 Apr. 2011 describing methods that allow the determination of the reliability of a location.

Although the foregoing developments in passcodes represent great strides, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 illustrates a simple schematic of a system whereby a user likes to initiate a transaction making use of a financial service such as an e-commerce or internet banking application adopting a method that differs in essence from the method currently in use;

FIG. 2 illustrates a simple schematic of a system as an improvement of the system of FIG. 1, namely, it illustrates a situation whereby the passcode uniqueness is enhanced by providing time and location information at the place where the transaction request was made;

FIG. 3 illustrates a simple schematic of a system as a further extension of FIGS. 1 and 2, wherein the passcode is not represented by a string of characters but takes the form of a picture that is unique to the user and is always the same for such user independent of the transaction requested;

FIG. 4 illustrates a simple schematic of a system of further improvements of the systems of FIGS. 1-3, whereby the dynamic picture TAN will now also comprise or is uniquely associated to time and location information identifying when and where such TAN has been produced and/or the transaction has been initiated and/or expected to be executed;

FIG. 5 illustrates a simple schematic of a system that provides a further improving feature of FIG. 4, whereby the location and time aware dynamic picture;

FIG. 6 illustrates a simple schematic of a system that shows a scenario where authentication is performed by an authenticating instance using context information received from the user;

FIGS. 7A-D illustrates a simple schematic of a system with different methods how the current four digit PIN passcode may be improved by using the user prior knowledge of the composition of the users individual PIN code;

FIG. 8 illustrates a simple schematic of a system that describes a random generation code system using a PIN; and

FIG. 9 illustrates a simple schematic of a system as an example where a traditional 2-dimensional QRC can be transformed into a 3D eQRC.

While the system and method of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the apparatus and method are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of the present application will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

This invention relates to apparatus, methods and systems for ensuring the quality and strength of passcodes and the verification and validation of their provisioning and the associated process as part of a security system that establishes the authenticity of passcodes provided by a person or more generally by any passcode generating human or machine instance hereafter referred to as user.

This relates in particular to apparatus, methods and systems using passcodes comprising their security attributes, that contain time and location characteristics together with other contextual information to ensuring improved security for transactional systems such as those applied in access control management systems. They inter alia comprise digital and physical systems that are used by Financial Institutions (FI), Insurance Companies (IC) as well as other industries such as transport security and personal protection firms.

Authentication systems require inter alia that the user provides verifiable credentials to a verification instance in order to enable the authentication system to establish the authenticity of the person or generally speaking an object that require authentication before such object be allowed into an access controlled restricted area. Such process is performed by using so-called authentication factors that are essentially associated to what the passcode providing instance knows, has or represents. The instance referred to maybe the person requesting and requiring access but it may also be a 3^{rd} party or proxy that provides such credentials in lieu of the person that need to be authenticated before access can be granted.

Authentication usually comprises three different credential or factors. The “has credential” is often a token such as a (smart)card, a passport, a badge or similar identification means while the “representation credential” is often a biometric characteristic such as a fingerprint, an iris scan or the person's DNA (DeoxyriboNucleic Acid).

The “know credential” is usually associated to a password, a passphrase or passcode provided by the user and that in addition to its user identity (leaving aside the authentication system) is not necessarily exclusively known to him. Such process enhances the authentication process hence increasing the level of security adopted by the access control management system or similar.

In most cases however requesting access to restricted electronic domains require the provisioning of a unique and personal passcode only known to the user and the authenticator. Such secret code ensures that only legitimate users can get access into such restricted area or domain particularly. This is particularly important when such domain authorises the execution of transactions involving important sums of money at the request of or on behalf of the user.

The user should provide the authentication process with a passcode in such a way that such passcode will remain secret and will not be divulged to—or can be intercepted by—third parties. For obvious reasons hackers and cyber-criminals are interested to obtaining such credentials making use of e.g. recording techniques such as keystroke or data-loggers or cameras or by spoofing or eavesdropping.

Failure to properly protect such credentials so may result in significantly weakening of the integrity aspects within the authentication process and indeed the overall system thereby compromising the ability to reliably and properly perform its authentication function resulting in compromised systems. Examples of such systems are credit card or mobile payments, access control management systems or indeed any system or procedure that is tasked to guard and protect a physical area or digital domain.

Authorization systems usually complement authentication systems which comprise e.g., identification, verification and validation processes. The authorizing instance will, after that the requesting user has been positively authenticated, usually grant rights or privileges to enable the user to request or to instruct the secured system to execute a specific task such as the payment of a bill within a financial transaction system.

The importance of properly maintaining access systems that use strong passcodes is evidenced by the increasingly number of attempts trying to steal, copy, forge or reverse engineer passcodes (or similar credentials). Even simple email or personal storage application require a proper passcode and it is clear that more complex that store important enterprise or government data require even stronger passcode systems that are sometimes composed of dual passcodes in addition to other authentication credentials used.

Sometimes, in order to make passcodes more difficult to crack, use is made of encryption techniques to hide or obfuscate the original passcode into a derivative code. This can be performed in a two-way process (encryption/decryption) or a one-way process whereby a unique hash is produced that makes a reversal of the hash into the original passcode impossible.

This disclosure describes the innovative process how password generation and their provisioning can be improved substantially by associating such generation and provisioning to the place where such generation has taken place in addition to the absolute time such password (or the associated provision) was made. More particular this disclosure describes how the original passcode morphs into a passcodebis which is a derivative or next generation of the original password because of attributing the time and location aware and possible other context credentials to the original.

This process can be repeated or cascaded at any significant moment within the transaction processing chain, thereby creating the further generation of passcodes, passcodebisbis etc. The layers of time and location aware credentials can be removed again and by “peeling off” the different layers it is possible to obtain the initial passcode.

Unless stated otherwise this disclosure considers authorization as a distinctive individual process that receives relevant authentication information based on the assessment whether the passcode(s) and possibly other credentials are authentic. More sophisticated and elaborate passcode systems have been introduced during the last couple of years to improve the security of sensitive electronic systems. Especially now that companies and public authorities keep their data “in the cloud” improved access security is required.

A variety of modernized passcode systems have been introduced whereby the introduction of OTP (One Time Passcode) has been an important milestone. Moreover the uniqueness of an OTP has been enhanced by introducing Time based OTP, a method whereby the OTP carries a limited time with restricted validity. After expiration of the predefined time interval any unused passcode will become irrevocable invalid.

Passcodes are usually comprised of one string of characters that do not differentiate in form, style, color or other similar attributes. Nowadays we see a certain trend whereby the passcode is effectively composed of more than one single set of character strings only.

In the majority of passcode requiring systems an uppercase character “A” used in a passcode is normally different from a lowercase “a”, but usually no difference is made whether the “A” or “a” is—for example—written in the color black, red or blue, or is presented in different font types such as “arial” or “courier” for as long the sequence of the individual characters remains identical to the one known to the authenticating instance. The underlying assumption is the requirement to keep a passcode in a human readable format.

Especially when the user is a person passcodes need to be human readable, not containing difficult to memorize special characters and may not be too long in order to maintain the basic understanding that a user should not write the passcode on a piece of paper while memorizing would be too difficult and errors to frequent.

These restrictions though reduce the possibilities to use strong passcodes and are an incentive to avoiding making errors. As a consequence users opt for passcodes that can easily be hacked within minutes or less when using specially configured (clusters of) computers to crack with the help of computer generated passcode lists (a.k.a. rainbow tables).

The above difficulties in designing strong passcodes for security purposes and that are adopted while regarded convenient by the user community has become a real challenge especially in view of the matter at stake. Proper passcodes will be beneficial for systems that manage privacy and data protection applications used to safeguarding and protecting critical infrastructures such as our payments settlement systems, public transports as well as power and other utility grids.

In order to overcome the previously cited problems it may be considered to adopt passcodes that have first of all an-once-used-then-invalidate characteristic are OTP that secondly have a limited lifetime and that are dependent on time and location characteristics such as the time and location a passcode may be used or in case of machine generated passcodes on the time and location such passcode has been created. They may also have attributes that contain other context aware elements such as sensor derived data, whereby such sensors may include sensors that are built into vehicles ranging from bicycles and cars but also may include sensors that are carried by air-planes and satellites.

Passcodes usually have to comply with a series of rules or policies enabling the authenticating instance to check whether such passcode is legitimate and correct. Traditionally the most important criterion is the definition of the eligible character set (as mentioned above) in combination with the length and possibly structure of the passcode. As an example the Personal Identification Number (PIN) used by bankcards are composed of four digits, which must be selected from the Arabic numerals 0 to 9 (i.e. ten digits).

Unfortunately the use of passcodes in the form of a string of characters has become problematic in security terms in view of the continuous increase in computer power availability aimed at cracking passwords at ever lower cost. Specially designed password crackers hard- and software is available and equipping off-the-shelf computers with Graphical Processing Units (GPU) and linking them to each other or configuring them are part of a network of GPUs has made sophisticated password cracking available to the general public.

However when passcodes in the form of a string of characters will be improved by attributing such passcodes with characteristics enabling the user to modify the passcode by changing the format, shape, form or style, the color or combination or combinations thereof then it is evident that it will become extremely difficult to crack the password secret within an acceptable time-frame while these attributes will significantly lower the chances to break the passcode thanks to the increase in the number of possible variations that can be generated.

It should be understood that while usually passcodes are considered as a string of characters associated with the attributes as were mentioned before, such passcodes should in fact be considered as a visual representation of a symbol or symbols or as a picture rather than a string.

Composing a picture or sequence or combination of pictures is in fact a representation of many parts whereby each picture should be regarded as a composite of images. These may comprise pictures made by a person such as a drawing or may be produced by a device such as a photograph by a camera, may be still like a single drawing or dynamic in sequence like a cartoon or like a video being a sequence of still pictures.

Also a picture in a picture or pictures within a picture or strings of characters or symbols that are hidden into a picture a.k.a. steganography are considered as a passcode for the purpose of this disclosure. For the purpose of this disclosure similar terminology used such as “password”, passphrase“, “token”, “credential”, TAN (TransAction Number) or similar is considered as a passcode as well.

Internet-based systems requiring digital access control such as mailing systems usually require a minimum of 6 to 8 characters up to sometimes 15 characters whereby the user is often obliged to use a combination of upper and lower alphabetic characters and at least one numerical character. Such complication of the passcode should prevent that users apply easy guessable passcodes thereby increasing the chances that such codes will be hacked for instance by using brute force techniques.

Usually security standards require that the transmission of passcodes over the communication channel is not performed in the clear while sending from the passcode interface to the passcode checking instance. Therefore passcodes need to be protected against snooping man-in-the-middle when transiting between the legitimate passcode provider and the authentication instance that checks the authenticity of the passcode or credential. The traditional method to protect the communication is by securing such transmissions applying tunnel technology such as SSL/TLS. Another possibility is to protect the interception of the passcode by hiding the code amid not relevant data and subsequently apply an algorithm that extracts the proper code. This is of particular interest when the code is not an alphanumeric word like a graphical representation composed of pixels whereby only specific pixels are needed to compose the code needed.

The need to making passcode complexity even higher and more complicated to decipher is mainly caused by hackers” ability to use sophisticated means to try to crack such vulnerable passcodes. Available high-performance cloud computing resources can now be “leased” at relatively low cost making it relatively simple to brute force attack complex passcodes. At the same time passcodes can be generated making it easy to build dictionaries of the most popular passcodes in use (a.k.a. rainbow tables). In the meantime this ecosystem has become so sophisticated that hackers positioned at the lower ends of the food chain are capable to purchase such rainbow tables for their specific purposes.

These developments mean that the concept of passwords needs to be changed as it does not provide the level of security anymore required to protect sensitive physical and digital areas or assets from unauthorized access or theft. Data protection, personal but also corporate privacy and identity are at risk and many more sensitive areas at stake.

The authentication aspects of the invention described herein may be beneficial for various categories of solutions thanks to the universality of the methodology that can be deployed in many different scenarios examples of which are: Secure provisioning of the context aware authentication credential identifying the user to a separate authorization instance within a chain of transactional steps; Stand-alone services or appliances ensuring the secure communication of sensitive and restricted information from one mobile or static node to other stand-alone or networked nodes mobile or not; Access services within a individual appliances or physical area or electronic domain whereby a user is granted access to applications or restricted areas or domains within or associated with the appliance on the basis of a passcode; and Appliances and devices for use by the general public as well as appliances and devices serving special purposes or designed for performing specialized tasks.

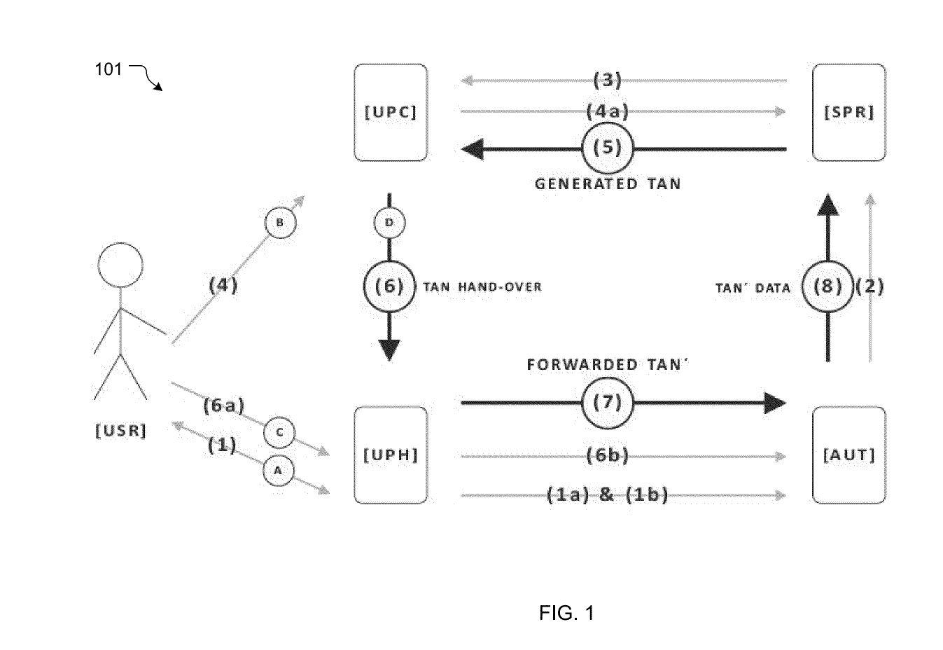

FIG. 1 illustrates a schematic of a system 101 in accordance to a preferred embodiment of the present application. FIG. 1 illustrates a scenario whereby a user [USR] likes to initiate a transaction making use of a financial service such as an e-commerce or internet banking application adopting a method that differs in essence from the method currently in use.

Currently systems usually require credentials from a user who provides a static user identifier (UID) together with the associated secret static PIN (Personal Identification Number) as a passcode.

In many mobile applications a TransAction Number (TAN) is used as an identifier that associates the payment instruction given by the user with the financial operation (to be) executed by the Financial Institution (FI) or in lieu of the PIN. In such case the TAN becomes one of the credentials used for authenticating the user and is hence a code that can be considered as a passcode.

In certain current implementations the TAN is a simple one-time passcode having limited time validity however in other implementations a more comprehensive TAN may be used whereby the TAN comprises the transaction details such as the amount, the date or even beneficiary information and similar data rendering the TAN unique.

This disclosure adds specific time and location as well as contextual attributes to the passcode so that the code becomes even more difficult to spoof, to copy or to replay without being noticed by the authenticating instance and/or the user.

[USR] initiates a transaction request using to purchase and to pay for a good or service via an e-commerce application on the mobile phone [UPH] or via a browser on the user PC [UPC] connected to an electronic communication system such as the internet.

[USR] uses a mobile terminal like a smartphone or tablet [UPH] to initiate the transaction request using (1). [UPH] is equipped with location detecting sensors such as a GNSS receiver and contains furthermore embedded features to reliably obtain time and associated data enabling the accurate positioning of the [UPH] and transmitting this information in processes or non-processed format (1a).

Moreover the device [UPH] sends unique device credentials over (1b) to the authenticating instance [AUT] that now is capable to authenticate the [UPH] on the basis of the credential data received i.e. the device credentials and the time and location credentials belonging to the device [UPH] at the moment of the request.

[AUT] provides the required data possibly including transaction, user and device related information to the service provider [SPR] notifying the latter that [AUT] received a transaction request from the user [USR] via [UPH].

[SPR] may create the TAN code (or instruct an instance to do so) on the basis of information it has received from [AUT] over (2). Alternatively [AUT] creates the TAN (partly) on the basis of a policy agreed [SPR] using (2). The [SPR] notifies the [USR] explicitly or implicitly via the [UPC] over (3) that it is ready to accept transaction instructions. [USR] produces the transaction information using an application installed on the [UPC] like a web browser whereby such [USR] provided information is communicated via (4a) to [SPR].

[SPR] returns the TAN possibly with additional transaction confirmation data to the [UPC] via (5). The TAN is displayed via the installed application on the screen of the [UPC] and copied from the screen and complemented with the time and location aware information such copy action has been undertaken and relayed to the [UPH] via (6).

While the original TAN has been complemented with time and location aware information, the original TAN has transformed into TAN″ (TANbis). TAN″ will then be forwarded via (7) to [AUT] who will ensure forwarding TAN″ “as is” or after extraction or otherwise processing of the TAN″ to [SPR] for authentication purposes.

In case the original TAN would have been generated by [AUT] or in case [AUT] would have received TAN information e.g. by a return response via step (2) then such authentication may also be performed by [AUT].

A, B, C and D at (1), (4), (6) and (6a) are moments within the processing chain human interaction by [USR] is performed.

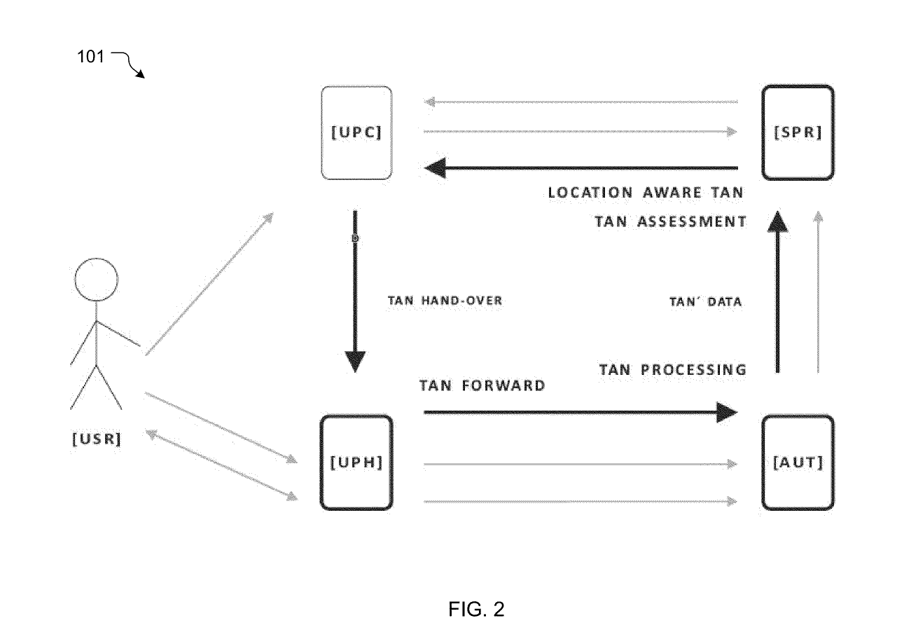

FIG. 2 is an improvement of the scenario described in FIG. 1. It describes a situation whereby the passcode (here in the form of a TAN) uniqueness is enhanced by providing time and location information at the place where the transaction request was made i.e. at [UPH] and/or the TAN was generated [SPR] or [AUT]. For security reasons the TAN content may be encrypted making it normally impossible for an attacker to steal TAN or transaction details. At [UPH] the TAN is simply displayed and no adaptations to the TAN code is made.

It should be noted that depending on the configuration the TAN may also be created at [AUT] who would then also perform the authentication tasks done by [SPR] as described here above.

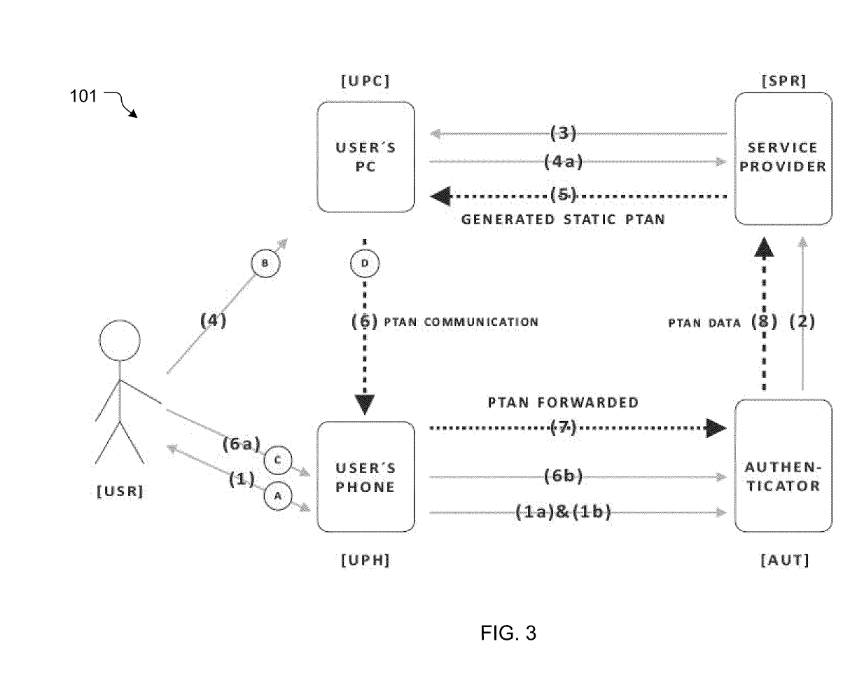

FIG. 3 is a further extension of the methods described in FIGS. 1 and 2 wherein the TAN passcode is not represented by a string of characters but takes the form of a picture that is unique to the user and is always the same for such user independent of the transaction requested. This picture TAN [PTAN] is static and may be compared to a static passcode such as the PIN that is used in current bank card transactions. The picture may be stored in the clear or in an encrypted format.

A further improvement can be made by making the picture TAN [PTAN] dynamic hence the [PTAN] becomes unique to each single transaction processed by the authenticator. The [PTAN] may contain certain transaction details in an embedded form.

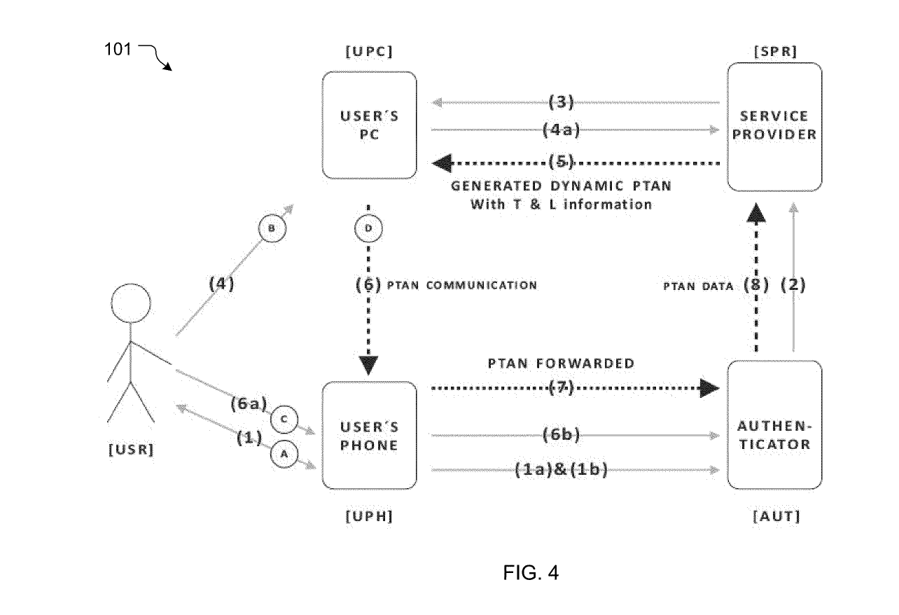

FIG. 4 is a further improvement, whereby the dynamic picture TAN will now also comprise or is uniquely associated to time and location information identifying when and where such TAN has been produced and/or the transaction has been initiated and/or expected to be executed. For security reasons the TAN content may be encrypted making it normally impossible for an attacker to steal transaction details.

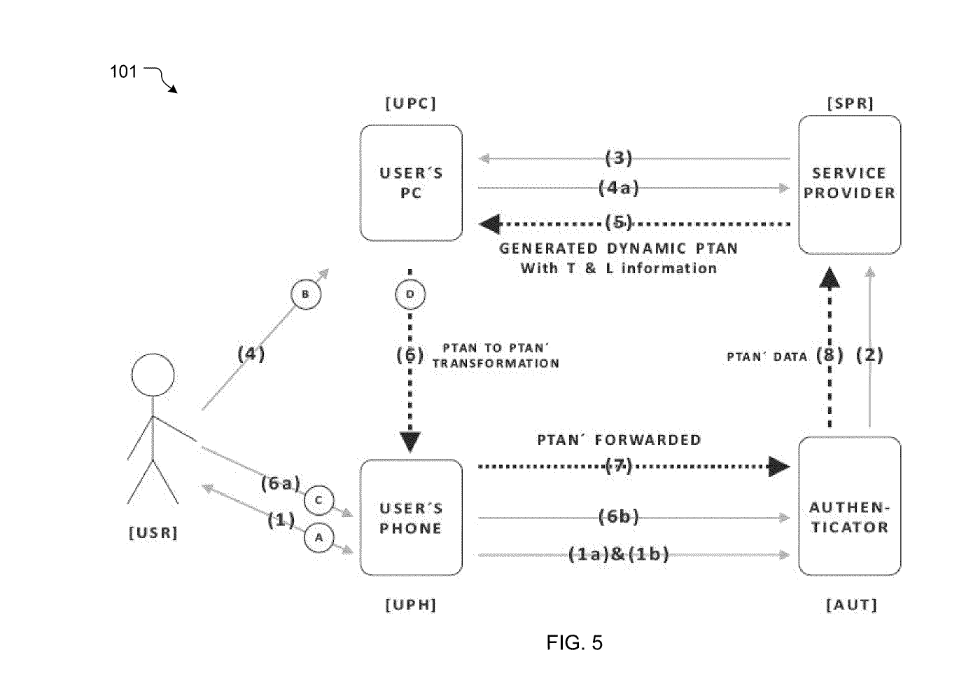

FIG. 5 provides a further improving feature whereby the location and time aware dynamic picture TAN [PTAN], that was issued by SPR] or any associated entity to [SPR], is sent via (5) to the user PC [UPC] after transformation using secret algorithms and methods into a [PTAN] that contains the features described in FIG. 4 but carries in addition a further time and location stamp added to the [PTAN] whenever it passes specifically designed procedural points within the transaction processing chain such as [UPC] and the users phone [UPH], via (6) and (7). The authenticator [AUT] analyses the [PTAN] and if needed extracts the [PTAN] in order to obtain the information that may be included therein. It should be noted that the [PTAN] changes every time a further time and location “layer” has been added to the core [PTAN]. This basically has the effect that the original passcode or TAN evolves into a [PTAN], then into a [PTAN″] and eventually into a [PTAN″] depending on the number of pre-defined transformation points within the overall authentication chain. This means that the graphical representation of the [PTAN] will change while its contents included in the [PTAN] is changing. Still the [PTAN] family characteristics remain intact and it will always be possible to determine to which family (and which generation within that family) such [PTAN] belongs.

The unique time and location aware credentials belonging to a specific generation of the family which is contained in each layer are to a certain degree interdependent and they may be compared to the different (year)rings that form the trunk of a tree. By peeling off the different time and location layers or rings it is possible to obtain the initial passcode again.

There are different methods to add or cascade a time and location layer thereby creating the next generation TAN. In the simplest form a passcode string can be transcribed or copied and by—as an example—adding by appending the time and location data to it the passcode string changes its form but continue to contain the basic string of characters. This transformation can also be performed by changing its shape (e.g. by enlarging the characters), by giving it a different color or style or by taking a picture of the passcode. In such case the time and location stamp the picture thereby creating the next generation of passcodes. This example becomes even clearer when the original passcode is provided in the form of a picture.

The PTAN or Picture Code (PCODE) may be adapted in its shape, form or style, in color or combination or combinations thereof, even in such a way that the PCODE after the transformation does not resemble anymore—at least for the human eye—the pre-transformation passcode.

The PCODE may have a form and format which may be difficult to describe. Under certain conditions this may hamper the proper processing of the passcode and therefore it may be advantageous to define the PCODE in such a way whereby describing the passcode may become possible by using visually standardised components such as a graphical representation from which the form and format of the picture TAN may be generated. A particular form of the PCODE may by the QR Code described later in this disclosure.

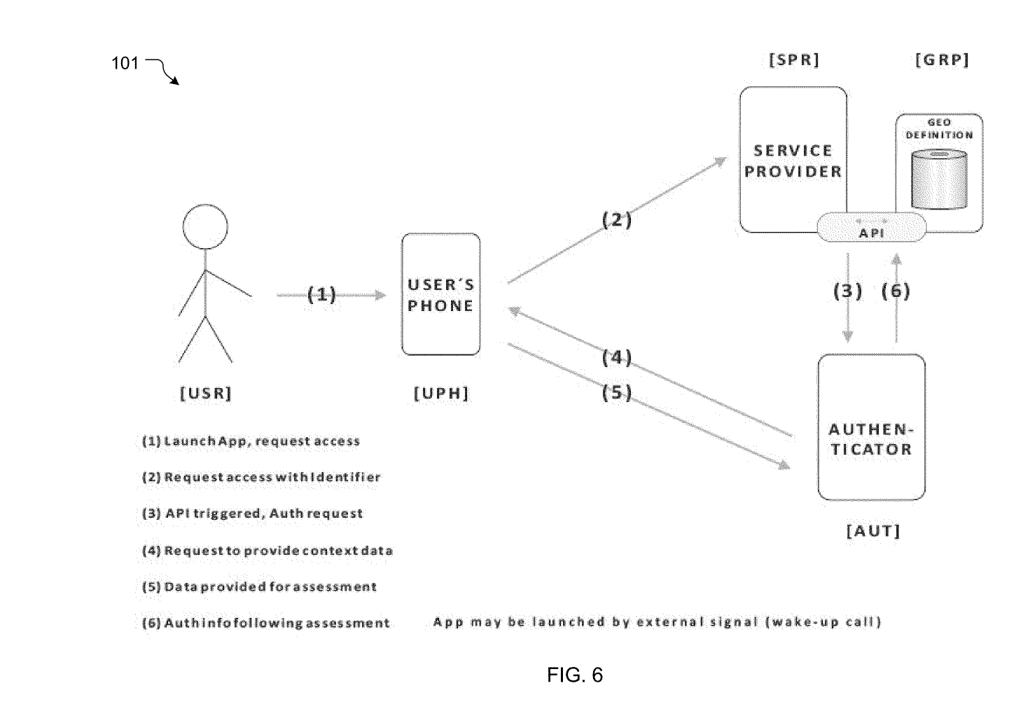

FIG. 6 shows a scenario where authentication is performed by an authenticating instance [AUT] using context information received from the user via his [UPH].

Departing from a passcode widely in use such as the well known PIN code which is composed of four digits the following illustrations describe the innovation.

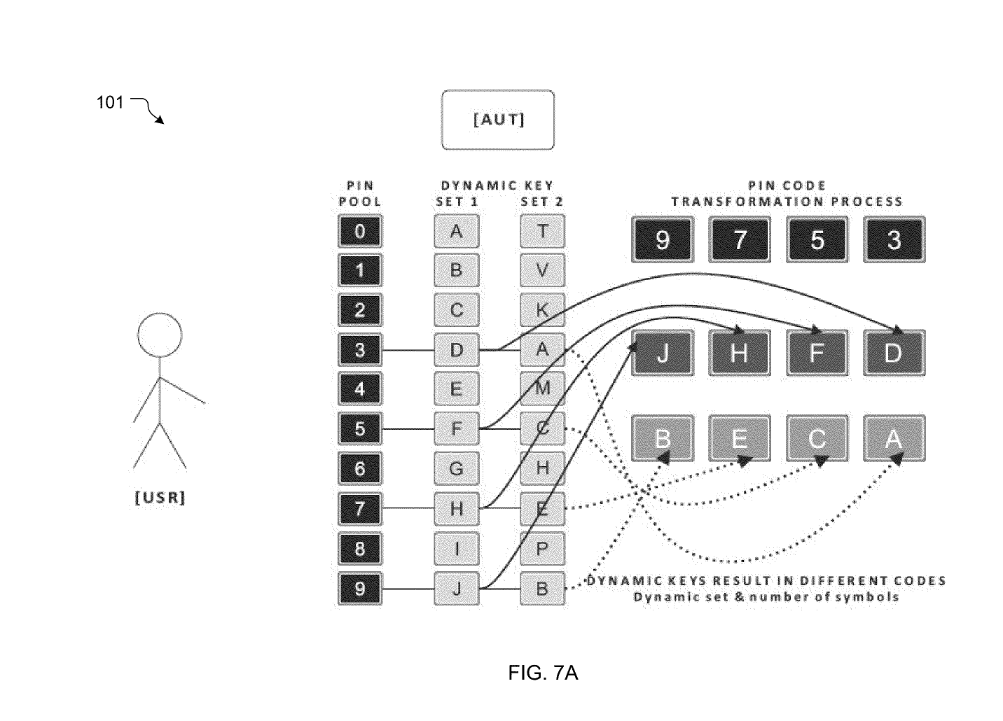

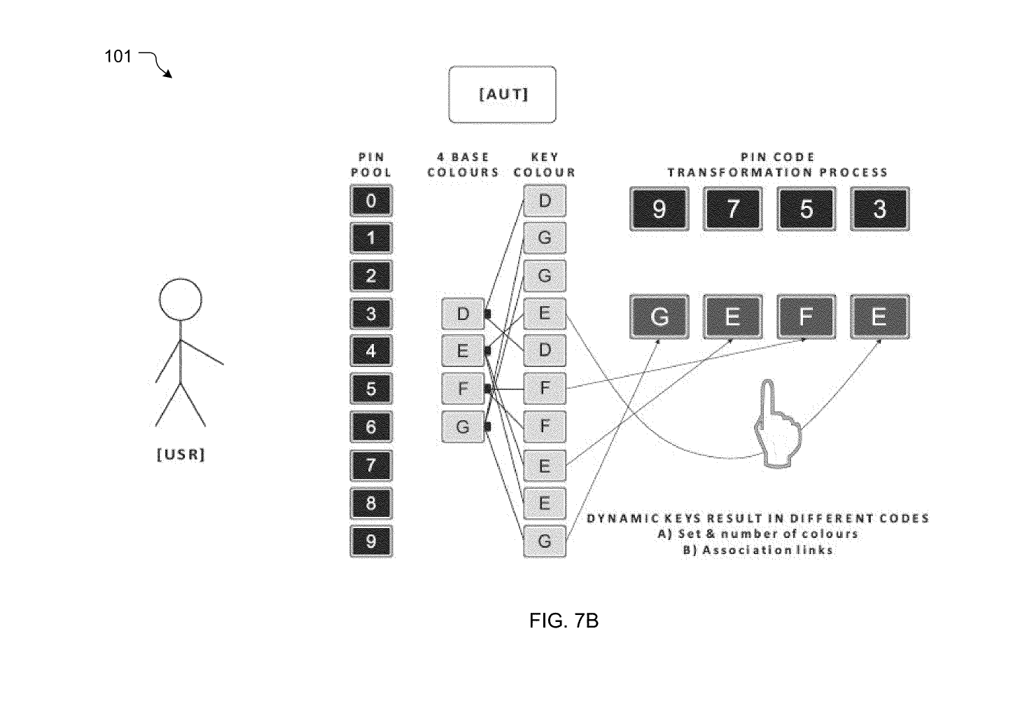

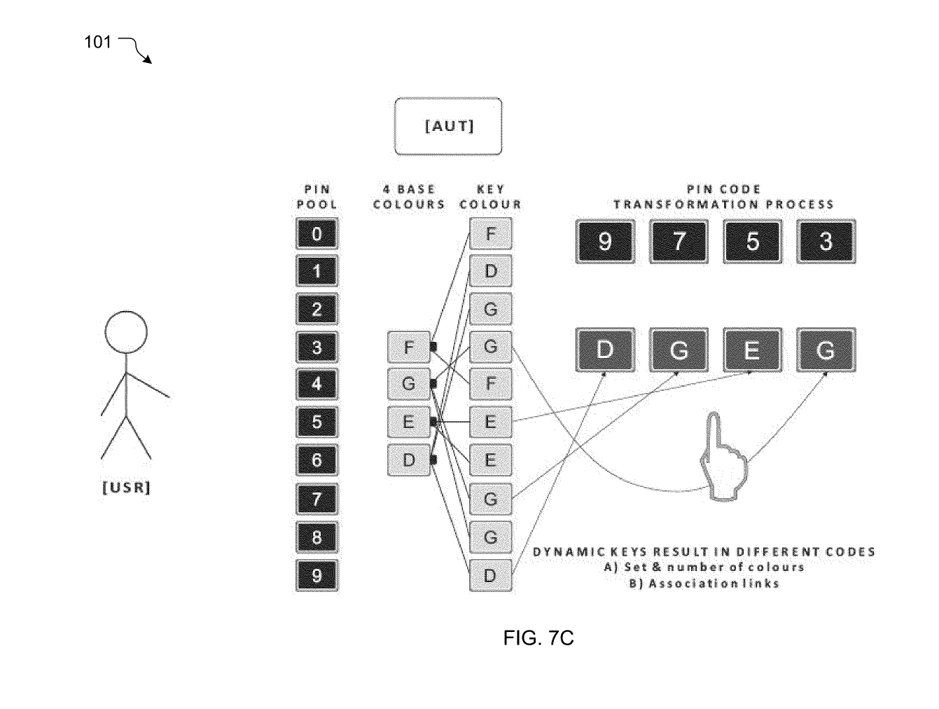

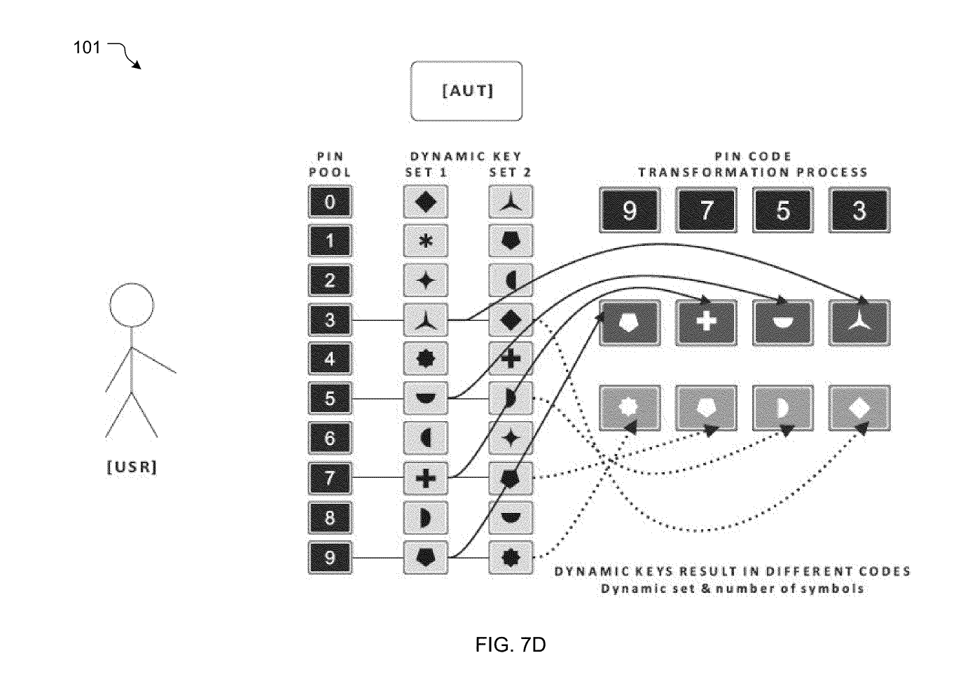

FIGS. 7 describe different methods how the current four digit PIN passcode may be improved by using the user' prior knowledge of the composition of the user's individual PIN code. The user [USR] “adapts” its own and known PIN code using a set of dynamic keys that are provided by the authenticating (or similar) instance [AUT] into a new code after transformation each the user request an authentication process i.e. when requesting a mobile payment.

The user's four digit numeric PIN code uses 0 to 9 as the pool of digits. The dynamic keys as shown in FIG. 7a are provided by the authenticating instance and when SET 1 is used the PIN originally 9753 will be transformed into JHFD in function of the Dynamic Key SET 1. To show the dynamic element the same PIN 9753 will become BECA whenever Dynamic Key SET 2 would have been used.

As an example the user may perform the transformation with the assistance of a touch screen on his mobile device. In order to enhance the security, it will be possible to attribute a limited validity in time and/or define the transformed PIN as a One-Time-PIN meaning that as soon the PIN has been used or has been time-out such PIN becomes invalid for the intended transaction.

Here the dynamic keys are represented as alphabetic characters however the individual keys maybe part of a much larger pool of characters, numerical and special characters like those comprised in the ASCII coding.

Moreover the dynamic keys may not only be represented by ASCII (American Standard Code for Information Interchange) or similar character sets, they may be composed of colors, forms (triangles, squares, circles etc.) or combinations of characters, colors and forms, styles etc. thereby creating a much larger pool of symbols as the basis for establishing an improved PIN.

In fact, when the definition of the current numeric PIN would be extended into a Personal Identification Code which may also contain an extended character set such as ASCII then a much larger number of PINs can be created.

A further improvement (security-wise but not necessarily convenience-wise) may be the introduction of visual forms such as clip arts, pictograms, etc. to even more enlarge the pool of symbols that are used to personalise a code.

In FIG. 7b describes a random generation code system using a PIN (here 9/7/5/3) adopting a sub-set of the method described in FIG. 7a where a reduced character (only numerical) set is implemented together with in this case four random base colors provided by the authenticating instance. The latter associates these four base colors with the numerical set of used symbols using a random association key.

Using the above methods the original PIN will then be transformed using dynamic color keys into a dynamic PIN resulting in the sequence G instead of 9, E instead of 7, F instead of 5 and E instead of 3. As a consequence the static PIN has been transformed into a dynamic PIN.

Referring to FIG. 7c the order of the base colors has been changed. The association key remains the same. This small adaptation results in a dynamic key that is different from the one originally obtained in FIG. 7b showcasing the dynamics when changing a simple element of the equation.

Advantageously the number of colors or the choice of colors to be used or used in FIGS. 7b and 7c for obtaining the dynamic code may be extended so that the possible dynamic PINs can be larger. However as this method is used to authenticate the transaction that usually is short in time one may compromise the security aspect in favor of convenience in order to facilitate the adoption by the end-user.

FIG. 7d shows a case where the symbol set has been expanded and the dynamic keys are now different forms making the process more versatile and which offers many more code generation possibilities compared to the previous cases.

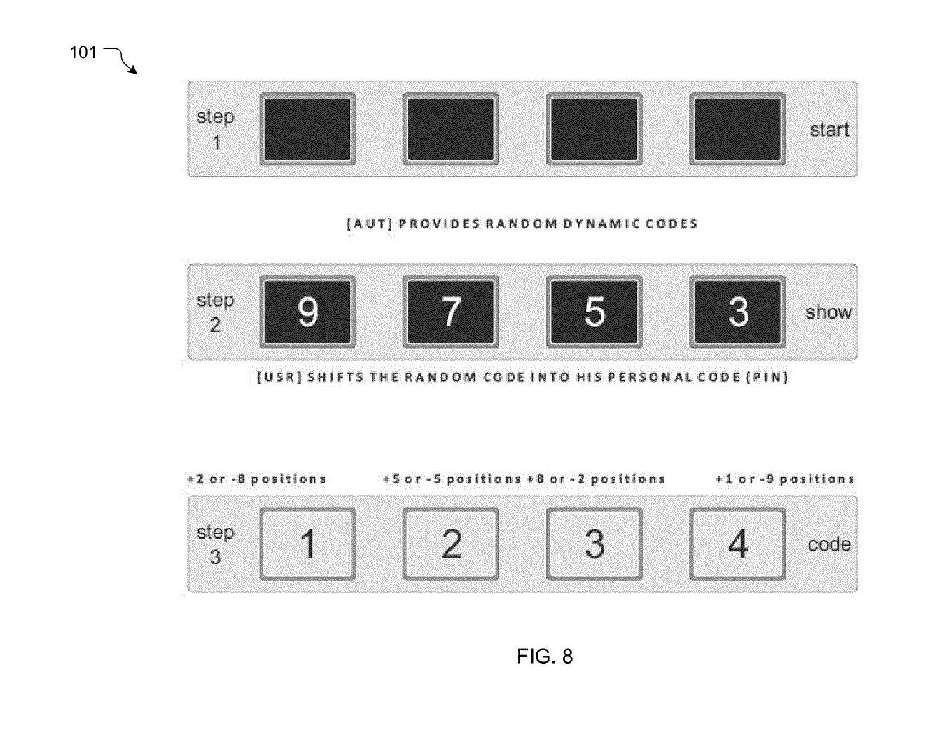

FIG. 8 describes a random generation code system using a PIN (here 1/2/3/4). The process is started in step 1 by presenting to the user empty individual boxes wherein no numbers appear (i.e. are not shown) hence making it impossible to visually observe or intercept the start positions of the individual numbers that appear in the boxes.

After starting the code generation in step 2, four randomly generated numbers, one each per box, will be generated by the authenticating (or similar) instance [AUT] and they are subsequently shown to the user. This random generating process will every time produce a starting position that is different from the previous start. The user [USR] now has to move the numbers in each individual box in such away the [USR] obtains his PIN as part of step 3.

The interaction performed by the [USR] means that a number of positions needs to be shifted to arrive (for box 1) from 9 to 1. This requires two positions forward or eight positions backward. Box two requires 5 positions forward or backward and so on.

Shifting the number of positions will be different each time while a different starting position is provided by the random generator. This has as a consequence that the shifting of positions on a per box basis will result in complete different outcome.

After having shifted the random generated numbers to the proper passcode the user has now the possibility (again) to visually check the correctness of such code and when proven to be correct the user may then pass on the passcode securely during step 3 to the next stage of the authentication process.

Of course the sequence of the digits do not need to follow the usual numerical pattern (i.e. 1, 2, 3, 4 etc.) but may be random. Moreover it goes without saying that the numbers used in the above description may be replaced with other alpha-numeric (special) characters, signs, symbols etc.

In summary in step 3 [USR] moves the numbers as if they were on a reel back-or forward as previously described to arrive at the known code. Apart from the randomly generated numbers a further element is added in step 2 to ensure improved security by complicating the passcode without hampering the convenience factor needed to achieve quick adoption.

As an example a color code layer may be added or a different form factor suggestions may be proposed such as circle, triangle etc. replacing the square previously use.

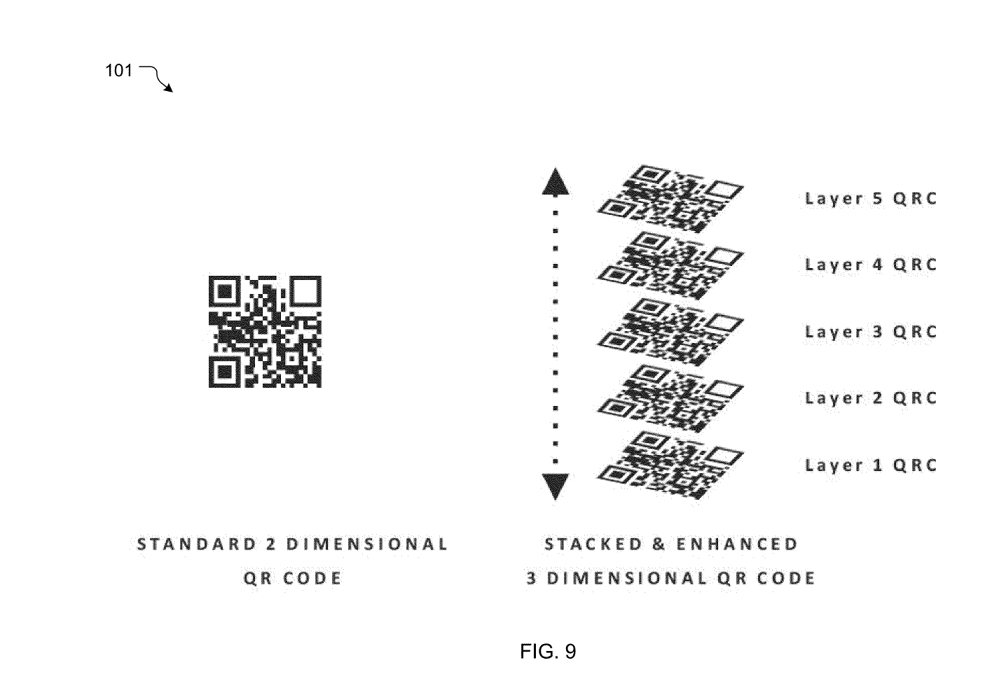

FIG. 9 is an example where a[PTAN] traditional 2 dimensional QRC can be transformed into a 3D eQRC whereby the individual QRCs are appended into a stack with different generations of QRCs as described in more detail later. Such a 3D QRC keeps the relevant generations of QRC together, creating a family tree of codes that belong to a single (group) of transactional business processes, all sharing the same core characteristics comparable to a DNA.

In any event it is shown above that further extensions of the basic method wherein the use of time and location data associated to the time and location the passcode is about to be generated is used to provide a further layer of security.

Such further layer of security may be represented by a fill pattern or structure applied to the color code, the shape or the number earlier described.

As explained further in this disclosure passcode generation and provisioning are events that can be associated with a specific moment in time. Passcode time stamping is a commonly used method applied by security system thereby “locking” the code generation or provisioning to precise time.

Location establishment may be performed by using ranging methods that use signal travel time in combination with the exact moment in time such positioning signal was sent by the signal source.

Combining these different aspects of time enables the accurate localization of the signal receiver so that the time stamping method referred to above can now be complemented with a location stamp which is unbreakably associated with the time stamp.

These stamps can be—in combination or individually—be translated into a representation of such two stamps which then can be used as a separate security layer.

In this FIG. 4—for reasons of easy visual distinction—such representation is shown as a fill pattern.

In the above Figures the number of the vertical rows has been shown for exemplary reasons as four distinct “reels”. Obviously they may be varied from the four shown to more than four to increase the complexity of the final passcode or to less than four to decrease such complexity.

Similarly using an increased number of finite characters set, signs and shapes etc. will significantly increase the possible end-results while decreasing them will result in a lower number of permutations.

Moreover it is clear that it is obvious for a person skilled in the art that the various features described above may be combined, adapted for combined use in order to improve or provide alternatives to the specific embodiments described herein.

The description above that describes methods associating certain security characteristics with a color, shape or pattern provides improved security while using known and basic natural conceptual elements which are globally adopted. Therefore any possible hurdle to deploy the methods described will be low and therefore a quick general adoption would be possible.

As previously mentioned the term “passcode” should be regarded in the widest possible sense for use as a credential in an authentication system. Usually a passcode is considered as one of the three authentication factors i.e. the credential the user “knows”. In this disclosure a passcode may also be a credential that was generated as part of an automated procedure without the knowledge of the user or without requiring his consent.

Such passcode may be composed of a string of characters that is composed of symbols that range from numerical only to ASCII (American Standard Code for Information Interchange) based characters in lower and/or upper-case as well as special characters not included in the ASCII character set.

Moreover the ASCII set includes the majority of variations of the Roman/Latin character set like some of the special German or Scandinavian characters as well as some other alphabets. However this disclosure also comprises the use of Arabic and other non-Western characters such as Chinese or Japanese signs or symbols, forms and/or shapes, colors and/or styles as well as any representation of a such character, sign, symbol, form, shape, color or style. In addition passcodes may be composed of symbols in the form of clip arts, pictograms or similar, individually or in combination thereof or maybe represented by a picture of pictures.

Similar terminology such as “password”, passphrase“, “token”, “TAN”, “PIN”, “credential” or similar are considered as a “passcode” within the meaning of this disclosure. A code composed of only “blanks” is considered as a special version of the passcode.

Passcodes usually have to comply with a series of rules or policies established by the authenticator in order to enable to safeguard passcode quality and to check whether such passcode is legitimate and correct. The most important criterion is the definition of the eligible character set (as mentioned above) in combination with the length and possibly structure of the passcode. As an example the Personal Identification Number (PIN) used by bankcards are composed of four digits, which must be selected from the Arabic numerals 0 to 9 (i.e. ten digits).

Internet-based access systems such as mailing systems usually require a minimum of 6 to 8 characters up to sometimes 15 characters whereby the user is often obliged to use a combination of upper and lower alphabetic characters and at least one numerical character. Such complication of the passcode should prevent that users apply easy detectable passcodes thereby increasing the chances that such codes will be hacked for instance by using brute force techniques.

It is now common practice that passcodes are not transmitted in the clear from the passcode interface onto the passcode checking instance. Such transmission is usually encrypted by using specially designed protocols. Moreover often a derivative of the passcode is used whereby the passcode is transformed into a further code usually using one-way encryption methods hence transforming the passcode in a so-called hash. This method creates a unique code from the passcode which cannot be reversed engineered. In case such one-way method is always resulting in a different unique code such hashing method is considered to provide collision free results.

Unfortunately the use of passcodes in the form of a string of characters has in security terms become problematic in view of increasing computer power at ever lower cost. Specially designed password crackers computers are nowadays equipped with Graphical Processing Units (GPU) and linked to each other or are part of a network of GPUs.

Available high-performance cloud computing resources can be “rented” at relatively low fees in order to crack complex passcodes or for generating dictionaries of the most popular passcodes in use (a.k.a. rainbow tables). In the meantime this eco-system has become so sophisticated that hackers positioned at the lower ends of the food chain are capable to purchase such rainbow tables for their specific purposes.

Modern technologies allow designing elaborate password cracking techniques and in various instances it has been shown that sophisticated computer configurations are capable to crack multi-billion passwords per second.

These developments mean that the concept of passwords needs to be changed as it does not provide the level of security anymore needed to protect sensitive physical and digital areas or assets from unauthorized access or theft. Data protection, personal but also corporate privacy and identity are at risk and many more sensitive areas at stake.

Passcode in the Form of a Graphical Representation

As previously mentioned the term “passcode” is usually associated with a string of characters or a set of symbols that are used as the user credential required for entering access controlled areas or more general environments. However also other categories passcodes may be used in access control systems like the visual or voice representation of the user to serve as an authentication credential.

While these categories of passcodes seem to be attractive for authentication purposes a series of underlying issues render them in many cases less useful. Still to underscore the potential application of visual or graphical representation that is not directly related to the user and which may be in the form of a codified picture the following example is provided.

In warehouses and in shops barcodes have been in use for over 50 years. They are a graphical representation of information which is difficult to decipher for the human eye while it is composed of vertical bars with spaces in between only. Specially designed (laser) scanners are capable to quickly read and translate the information contained in the barcode into information understandable for human (and machine) use.

An improvement of the barcode is the so-called QR (Quick Response) Code (or QRC) a technology that also provide a graphical representation of information in a two dimensional format just like the barcode mentioned above. The QRC was invented (and subsequently patented) by the Japanese company Denso Wave in 1994 originally designed to keep track of automotive parts. In the meantime hundreds of QRC related patents were filed.

The case can be made to extend the current 2 dimensional version of the QRC into a three dimensional version whereby the QRC can take the shape of a cubicle or similar 3D object. This would imply a format that is composed of 6 times a 2 dimensional square QRC or if another shape would be chosen such as in a triangular shaped code at least four surfaces would have to be covered with a QR similar code (not 2 dimensional squares but having another shape).

One can also define a 3 dimensional code differently whereby the 2 dimensional QRC are “stacked” upon each other which automatically means that any group of at least 2 QRC stacked codes will become a 3 dimensional QRC. Such stacking is of particular interest when different generations of codes belonging to the same family are grouped into one 3D QRC.

Later in this document it is disclosed how such 3D QRC is used and how generations of QRC or enhanced QRC (eQRC) can become an important new context aware passcode that includes time and location attributes as well as other data derived from sensors that may be terrestrial (like sensors built-in smartphones or other portable and mobile devices like watches, jewelry etc.)

While the QRC in itself is not secure as such while the information can easily be read and interpreted by QR readers or scanners, it is an effective method to relay information in a dense format. QRC's features such as the format and position as well as the built-in error correction have contributed to the wide spread adoption of the QRC especially after the introduction of the smartphone. It can be readily be equipped with apps that can easily read the QRC notably for using the QRC as URL shortened, thus offering the possibility to quickly point to a long internet address.

The intrinsic capabilities offered by a QRC to “hide” several hundreds of characters in its picture makes that such QRC is potentially an interesting carrier of concealed information like long and dynamic passcodes. Unfortunately as previously mentioned the fact that such hidden information can easily be extracted makes its use as password carrier normally obsolete.

There are two cases though wherein such drawback is not a real issue. Firstly in cases where the QRC content would be encrypted and whenever decryption would not be a problem for any authorized party, than a QRC may well be serving as a passcode carrier.

The same applies when the unencrypted content is difficult to replicate taking into account the time latency any hacker needs to take into account before using such passcode in a hacking attack.

While the QRC may contain ultra long numeric, alphanumeric, binary and Kanji' symbols and characters it is particularly useful to use it as a bearer of extensive data compacted into messages that may be up to 4296 characters long when using the alphanumeric character set (in line with the QR standard). Hence such message may include standard passcode information together with time and location data and complemented with any other contextual information such as source and transaction data and for as long as the message does not exceed the said 4296 character length.

In case such message is compacted using proprietary algorithms an implicit encryption would be realized. Extracting the message is an easy standard procedure especially when a smartphone or tablet device installed app would be used. A de facto scan of the QRC is made by taking a picture and software installed by the mobile device is capable to extract the message and its content quasi real-time.

Assuming that via decryption only authorized users are capable to properly read the message the QRC message has now become a secret passcode that contains information related to time and location as well as context information such as transactional data.

Even if the message is not encrypted or concealed and is readable for anyone capable to process the enhanced QRC than it would still be possible to hide information into the 4296 character long string that would suffice for serving as a secure passcode. An algorithm that defines which of the 4296 characters within the message would constitute the real passcode would result in a secret that is difficult to decipher in real time especially when such the message content has a short validity lifetime. Even if the passcode would be composed of a limited length it would be close to impossible to process all the possible combinations out of 4296 characters within the time frame of the validity of the message.

The enhanced QRC (eQRC) described above as an 3D QRC would comprise the elements of time as well as of location would offer even many more options when the eQRC would be propagated in the sense that the eQRC would be the basis of a further generation or generations of eQRCs.

Assuming that the eQRC would be part of a business or manufacturing process requiring high security then such eQRC could be equipped with further sets or layers of contextual data or transaction data whenever such eQRC would pass an instance within the overall chain. When these layers are comprised in QRC that are appended (or stacked) to the previous generation of QRC the earlier reference 3D QRC is created.

This “new born” eQRC includes a further generation of the original passcode that was contained in the very first QRC message and while the shape of the QRC differs from generation to generation (while the contents defines the little squares or “pixels” that shape the QRC) it is a perfect example of the earlier referenced method of a changing but chained picture that could be used for authentication purposes.

This process and method not only ensures the authenticity of the original passcode but provides time and location information on the birth of a new generation of the original QRC containing the original message, but also provides a method how insure standard QR Codes can be secured by tracking the QRCs route within a (business process) together with the context of the routing, the handover at each predefined points and the eventual new generation of the eQRC.

An example of a typical business process may be in the area of e-commerce. Different stages of the process can be linked in a secure way while the previous step of the overall chain can be linked to the following step. Whenever a consumer pre-selects or reserves a product on a website with the intention to purchase it a eQRC can be created. The actual ordering (the check-out) would be the next step in the chain leading to an adapted version e.g., a EQRCbis of the initial unique eQRC. The Check-out will lead to a payment, a step which would lead to a further generation of the eQRC, now becoming the eQRCbisbis then leading to the fulfillment stage that comprises shipping, delivery, acceptance and so on.

All these events are descendants of the original, they have however adapted attributes whenever a further step in the chain has been passed. In the end it will be easy to associate a graphical representation from one generation to the other having the assurance that such chain of QRCs belong to the same family, where the parents and children can be traced back to their origins using time, location and any other relevant contextual information that has been included in the eQRC.

It should be noted that the creation of the next generation eQRC can be simple and fast. Using a smart scanner such as those embedded in an app that can be installed on a smartphone will enable the smooth and fast transition from one generation to the other. Assuming that such device contains GNSS receiving hardware and also contains the necessary sensor equipment then the creation of the next generation of eQRC is warranted.

The possibilities in an authentication process are numerous while the above process enables to identify a security chain associated with an transactional business process. Every single step within the business process that needs authentication security can now be associated with the measures that were applied to warrant the integrity of the business process.

Moreover the above method makes it possible to simplify governance, accounting as well as auditing processes thanks to the convenient and transparency enabled by such method that is complementary to existing processes and does not need the replacement of currently existing legacy systems.

### Passcode Recovery

Passcode recovery is usual a tedious procedure and prone to various attacks aimed at trying to get the passcode secret for illicit use. Methods trying to steal user's credentials are rising and often through sophisticated social engineering the thief tries to get hold of secondary information (such as the answer to a secret question) in order to obtain the passcode from the authenticator by spoofing the identity of the owner of the passcode.

Such problems are now gone while the above situation is only applicable when the passcode is static (or does not change for relatively long periods) and does not change overtime at all. While in the methods disclosed herein the change dynamics are of rather short intervals it is practically impossible to try to obtain the passcode using the method described above.

In fact any other attempt would fail closing the gap to steal passcode information thereby providing an elegant and simple means to avoid these kind of attacks.

### Provisioning

Passcodes are usually provided by a human user but more and more such provisioning is done by a digital instance or device such as smartphones and tablets. The standard method used in authentication foresees that a passcode front-end interface relays the passcode in a usually concealed and/or encrypted way to a back-end service connected via a wireline or wireless network.

However such provisioning may also be performed through an automated procedure triggered by a signal that has been enabled to communicate with the interface of the passcode receiving instance.

The means applied to provide the passcodes via such specially designed interface include direct human contact such as by a keystroke on a keyboard, via a mouse or similar apparatus such as a trackball, joystick, game pad etc. or via non-human contact like robotic devices performing the afore-said interactions.

In addition e.g. when using a touch screen based input interface such means may comprise stylus-pens and similar touch or non-touch pointing devices such as laser-pens or via voice, eye or human body controlled devices as are in use for gaming, virtual and augmented reality applications amongst others.

The interface may be a stand-alone software module incorporated into a computer program or application but can also be implemented as part of a hardware device and hard-code into a special purpose terminal, a game pad or even a vault that uses such interface to receive and possibly generate the key or passcode required to triggering a as an example a mechanism opening the vault for its users.

### Time and Location Aware Passcodes

Current understanding is that time dependent passcodes are usually associated with codes that have time limited validity or which may only be used once. Time dependency may also refer to the moment in time such passcode were issued, in fact creating a time stamp that is associated with such passcode. While the notion “time” has many different meanings it is important to properly define in this context the time factor to avoid any ambiguity.

This invention discloses systems and methods that refer to time as an absolute continuing progressing dimension whereby events can be put in a sequence (put in an order) from the past through the present using an absolute precise reference such as the as GPS time, being the time which is used as the basis for establishing the reference time for use by the GPS (and similar) satellite system(s). In order to associate time with location (or position) reference is made to the document “Global Positioning System Standard Positioning Service Signal Specification” second edition dated 2nd June 1995 as published by the US administration.

The way GPS and similar GNSS systems such as Galileo and Glonass operate means that positioning (i.e. the establishment of the location of the device that receives the relevant GNSS signals) has become a function of time. A number of signals broadcasted of at least 4 different satellites must be received in order to accurately determine the place on Earth the receiver is actually positioned using the travel time of the signal and the orbital position of the satellite emitting such signal.

With this in mind, this disclosure uses the wording “time and location” as a singular definition understanding that no location or position can be determined when the time factor (i.e. the time of travel of the signal) cannot not be properly established.

Moreover time is associated with a method of location establishment using ranging techniques whereby time and location are absolutely linked to each other while the moment in time radio frequency signals are emitted and the period of time such signals travel to arrive at a receiver capable to calculate the exact position that is valid only on one specific moment in time.

Other methods are available to aid the receiver to improve the speed to establish or the accuracy of the location determination. The establishment of the afore-mentioned time factor may be supported by using other sources of signals that can be used to aid the process to arrive at a proper location determination.

As an example A-GPS or assisted GPS measurement is mentioned, a method that aids the location determination through the provision of sensor and other data derived from other sources than the GNSS made available by a non GPS network (such as the GSM network) whereby satellite constellation data is acquired by the receiver in order to facilitate to “find” those satellites which according to the orbital parameters should be “seen” by the receiver. By enabling a quicker satellite fix the receiver is capable to fetch the travel times faster in order to establish a quicker positioning.

In fact GNSS (Global Navigation Satellite Systems) broadcast radio frequency signals that contain so-called messages that comprise amongst other data the above time and satellite constellation information. This enables any properly configured receiver stations on Earth to compute the position of the receiver while atomic clocks on-board the satellites are capable to produce nano-second accurate GPS time.

In case a passcode generating and provisioning appliance or device would have the capability to receive such GNSS messages either through its own built-in receiver capabilities or by being capable to attach receiver cum computing equipment to it then it would be possible as a first step to add time and location dependent features and/or identifiers to the passcode. It does not need further explanation to understand that other sensor acquired data can be used as well.

The GNSS message is structured according to a pre-determined format that inter alia contains satellite identifying information, constellation particulars in so-called ephemeris and almanac data as well as highly, nano second, accurate satellite clock data (i.e. time information). Such messages are used as the basis to establish accurate GNSS based time and locations.

Using the content of these messages that contain unique sets of time and spatial information as well as other contextual data such as satellite constellation data may be considered in cases where GNSS derived information is used to create passcodes or credentials that can be used in an authentication process. It is important to recall that the GNSS constellation are unique in time and space (see the disclosures contained in WO2011/048106 dated 28 Apr. 2011 as previously referred to) and that such unique event can be used as the basis for a GNSS derived credential for use in authentication system such as multifactor authentication system inter alia described in WO2010/043722 dated 22 Apr. 2010.

Furthermore it is recalled that one needs to receive four sets of messages (i.e. from four different GNSS satellites) to enable the proper processing of such data into a location where the receiver acquired these signals. It is also recalled that these messages are not identical and all contain different sets are data. Thus having access to continuously changing messages originating from different satellites moving in orbits around the globe will enable the creation of passcodes that are unique, valid for a limited time and are extremely difficult to replicate.

Having more and more independent GNSS in space will result in an even better quality of these passcodes while such codes may be generated using the different hence multi-GNSS constellations. In the future it will also be possible to have more satellites in view of the receiver. This situation makes it even more attractive to use GNSS data as the source for unique passcodes.

GNSS systems in a single constellation or in a multi-constellation set-up are often aided by so-called in-space SBAS (Satellite Based Augmentation System) used to improve location accuracy by providing correction data.

However even combining such augmentation systems such as EGNOS or WAAS will still result in problems associated with the indoor reception of satellite navigation data arise albeit less prominent when compared to using GNSS in a stand-alone configuration.

Although these GBAS satellites are contrary to GNSS satellites orbiting the Earth in a geosynchronous orbit and therefore will be less sensitive to reception problems compared to medium Earth orbiting GNSS satellites, it is still evident that the improvements of using SBAS for indoor situations is of only limited scope and benefit.

However the use of multi-constellation GNSS combined with multi-frequency systems, using augmented data and complemented with terrestrial systems providing location data will be a viable alternative in the near future.

Network of terrestrial nodes that mimics GNSS systems by providing GNSS like signal data to the mobile indoor user in a time-synchronised way are usually referred to as GBAS (Ground Based Augmentation System). These so-called pseudolite (pseudo-satellite) systems are ground based transmitter systems that may use exact the same signal data structure and may transmit them in the exact identical frequency spectrum as GNSS satellites.

In such case the pseudolite system enables the receiver to capture and process such data as were they “real” GNSS signals and signal message processing results in a proper location establishment. Such scenario would also warrant that no significant change to the COTS (Commercial Of The Shelf) GNSS receiving appliance needs to be made.

Other terrestrial ranging system systems such as WiFi and similar Radio Frequency (RF) based technologies use trilateration methods. Similar albeit less accurate results may be obtained using field strength measurements in combination with triangulation methods or similar methods. Location services offered by third party providers may also be used to obtain information on the whereabouts of the user and its receiver.

The ubiquitous availability of time and location information, the use of cheap COTS (Commercial Off The Shelf) appliances provides an opportunity to achieve a new dimension in passcode generation and provisioning especially if such time and location attributes would be sufficiently accurate and reliable to improve passcode authenticity.

Systems that securely manage authenticated passcode generation and provisioning in a stand-alone mode or as part of a passcode authentication system will be in a significantly better position to fend of fake passcodes attacks provided by illegitimate users. Systems adopting such improved passcode system would ensure a much higher degree of system integrity and thus overall security performance.

Therefore time and location aware passcodes are basically codes that are linked to or associated with unique and absolute time reference that enables to derive information to determine an accurate location determination.

### Context Aware Passcodes

While it may be assumed that pure time and location aware passcodes “only” add a layer of time and location information to the passcode it should be underlined that context aware passwords would add more than only the time factor to the passcode.

In fact multi-layered time and location credentials or other time related information such as the time from different independent sources or any time latency information would provide the contextual interrelationships so that the additional dimension needed to enable context aware passcodes is made available.

Other data which can be added or combined into the passcode may include any sensor data that would enhance the quality and/or quantity the context awareness that is associated with the passcode. As an example such codes might contain environmental information that is relevant for the time and location applicable for the moment the passcode was generated thereby providing the possibility to verify whether the combined set of time and location is plausible when comparing them with the sets(s) of other contextual data observed.

When using satellite derived information such as the previously mentioned time and location data, it will also be beneficial to consider technical data that is related to the satellites as such. Telemetry data which is available at that specific moment in time provides a further layer of context awareness applicable to the creation of the passcode.

### Passcode Validity Aspects

A further significant improvement may be obtained when the validity of the passcode would be dependent on a valid time and location window (or session) during which such passcode will be applicable (only).

At present current systems using time based passcodes often apply a policy setting a maximum lifetime or duration of the passcode validity. Whenever such passcode validity period has lapsed then a new passcode needs to be requested by the user, will then be subsequently be generated and communicated to the requester.

Setting such time limit inter alia avoids that a passcode generated at a specific moment in time can be indefinitely used as a result of its unlimited lifetime. Indefinite lifetime of passcodes increases the risks of fraud and abuse while stolen or forged passcode may be used without time restrictions until such fact has been detected. Therefore security systems usually apply a policy of time limiting the validity of passcodes generated by such systems.

The user would have to compromise on the convenience factor when intervals of passcode validity would be set too short thereby requiring that codes generation will be in not convenient and user-unfriendly short intervals. A major further disadvantage of such procedure can be found in opening the possibility to increasing the number of break-in attempts by trying to reverse engineer the passcode generation algorithms by continuous trial and error testing the generation process thereby seriously hampering the system security.

Such situation can be remedied when passcodes would remain valid over longer periods of time. This would be made possible when passcodes would continue to be valid on the condition that the location from where such passcode is provided remains within a certain pre-defined perimeter such as the corporate premises. Alternatively passcodes may continue to be valid only if they are provided from a previously known authorized location such as the address of a corporate customer.

In such cases the continuous generation and thus changing of the passcode would not be required anymore whereby security considerations would be fully and completely addressed.

In general under certain circumstances passcodes do not need to change anymore subject to the condition that these codes are bonded to an authorized location from where such passcode were provided before. This would significantly increase the user friendliness and the security of this system while corporate passcode policies would be much simpler to adhere to and no need exists to circumvent such policies only to ensure ease of use.

Moreover the user and the corporate system would now be protected while passcodes would be associated to a known authorized location. Passcode management may be a bit more elaborate however such perceived disadvantage would be outweighed by the numerous advantages in terms of usability and improved security.

A further advantage is that passcodes that are used at a given authorized location such as the corporate headquarters will continue to be valid even if already another passcode has been generated for another authorized remote location e.g. when the user visits a customer at the client's premises. In the end also this “passcode memory aspect” linking previous locations with their respective historic passwords will further greatly enhance user's readiness abiding to rules and policies that ensure improved levels of system security.

Especially when further conditions govern the use of historic passcode that were valid at previous locations then such method may also be applied by systems that require strong authentication procedures i.e. before granting rights and privileges to the user who is at a known authorized location such as the user's home office.

The increase in the number of teleworkers requires that more sophisticated methods need to be adopted to secure remote access to corporate intranets. Document and mail retrieval are provided to the remote worker requiring that business information containing corporate or customer data that is stored at the corporate premises or even away in the cloud can be viewed or may be made available to the teleworking user by providing gateways to such intranets or cloud services.

Leaving aside the data-communication security aspects of teleworking which may include encryption and the setting-up of secure tunnels through which the data is transmitted, the access control aspects become more and more important. Policies governing passcode generation and provisioning, the authentication of the identity of the remote user, the location where the user is requesting access from and the type of retrieval request the user initiated are all challenges which need to be addressed and solved.

When analyzing the increasing number and successful attempts where corporate networks as well as critical infrastructures such as power grids and utility systems were attacked and compromised from people and systems outside the authorized (corporate) perimeter and taking into account the impact such breaches may have had on the organization, its stakeholders, customer base and the civil society at large then it is not difficult to conclude that current solutions are not adequate and not coherent. The case for improved security systems where authenticated passcode management would play a primary role is clear and evident.

In a scenario or constellation where authentication services are operationally separated from authorization services such segregation of responsibilities will enable the use of time and location based passcodes as a single factor authentication credential that can easily be passed on to and thus implemented by an authorizing instance such as in physical access control systems used by the majority of corporate and organizations across the world.

### An Example of Context Aware Passcode Usage

Secured methodology mail and document retrieval from a remote location:

The location from where secured mail may be retrieved using an authenticated passcode that contains contextual information starts with an enrolment procedure where the base location can be a home office, customer site etc. These sites must be validated as an authorised location in order for the user to get access. This procedure that establishes the perimeter aspect of the location can be performed using methods assuring that the user is properly identified and the passcode applicable for such perimeter is authenticated. These methods may include confirmation messages sent by electronic means, by voice confirmation over phone, by video or biometric validation methods known to the art.

When after such enrolment procedure the user requires access to its corporate account such user applies the method generating a passcode described earlier in this disclosure. The passcode requires the inclusion of a time and location component to enable the corporate gateway to assert whether the code that has been provided belongs to a known authorised user of the corporate system (user identity validation) and whether the location from where the access request has been sent belongs to a group of authorised locations, possible associated to such individual user or to the group of authorised corporate users, that are registered as authorised access locations (perimeter validation).

The individual user passcode is complemented with contextual information resulting in a truly one-time-passcode (OTP) that increases the likelihood that the person using such code is indeed the legitimate user known to the system thereby reducing the risks that an unauthorised person is trying to abuse such code. The OTP is in this case complemented with an identifier that uniquely pinpoints to the user's location and the associated time such location information is valid. This results in a 2nd aspect of the code which is referred to as one-time-location-passcode.

In this connection it should be noted that the time component contained in the OTP is not only referring to the “valid once and use once” characteristic of the passcode it contains in fact a further time characteristic that is the unique time such OTP was generated, a further element of security.

The gateway belonging to the mail or document retrieval system will assert whether the conditions governing the access and possibly the retrieval are adhered to and upon positive confirmation thereof will grant the requested access. Subsequent retrieval may be subject to further verification processes usually referred to “authorisation” depending on the corporate policies in place.

Such corporate policies may also define the duration the user is allowed to have access to the system. This may mean that after a certain period of time or in case a event has been triggered such as the quantity or category of data that has been retrieved the access for that particular user will be shut down.

Furthermore depending on the policies and circumstances the user may be allowed or not to generate a further passcode allowing renewed access to the corporate system.

In an e-commerce transaction the process maybe as follows: the user likes to order a product via a web-service on the internet whereby he uses his mobile device as an authentication instrument; through the browser on his desktop computer he request a URL behind which a proxy service is securing the e-commerce process; the proxy site offer the user a unique time restricted QRC which the user must scan using an application that is installed on his mobile device. Within the QRC a long code is contained that points at the webshop where the product is on sale.

Upon scanning the QRC the mobile device sends (amended or not) the code within the QRC to the authenticating instance that controls the proxy and after proper verification decides to grant access to the user via a redirect page displayed by the proxy.

The user will now be at the (hidden) webshop where he may be requested to provide usual credentials or may be granted access without such usual authentication.

In fact the user does not know where the service is offered while he does not know the proper DNS he should be visiting to benefit of the services offered.

The security behind such convenient access solution is provided by using the earlier mentioned 3D QRC or eQRC which ensure that any single step (or transaction) is secured by an authenticated actions that is based upon time, location and possibly other sensor information that collectively or individually is referred to as context. Similar solutions are possible for using the desktop computer in an indoor environment, or a mobile device such as a tablet in a roaming scenario.

It is apparent that a system and method with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A three-dimensional quick response code, comprising:
a first quick response code; and
a second quick response code;
wherein the first quick response code is appended in a stack with the first response code;
wherein the first quick response code has a different generation than a generation of the second quick response code; and
wherein the stack creates a family tree of codes that belong to a single group of a transactional business process.
